(19) United States
(12) Patent Application Publication
(10) Pub. No.: US 2005/0264808 A1
(43) Pub. Date: Dec. 1, 2005

(54) Multi channel Raman spectroscopy system and method

(75) Inventor: Xiaomei Wang, Winchester, MA (US)

Correspondence Address: J GRANT HOUSTON;AXSUN TECHNOLOGIES INC, 1 FORTUNE DRIVE, BILLERICA, MA, 01821, US

(73) Assignee: Axsun Technologies, Inc., Billerica, MA (US)

(21) Appl. No.: 10/967,075

(22) Filed: Oct. 15, 2004

Related U.S. Application Data
(60) Provisional application No. 60/512,146, filed on Oct. 17, 2003.
(60) Provisional application No. 60/550,761, filed on Mar. 5, 2004.

(51) Int. Cl. G01J 3/28

(52) U.S. Cl. 356/328

(57) ABSTRACT

A spectrometer that provides the ability to combine the advantages of high resolution, compactness, ruggedness, and low-power consumption of Fabry-Perot (FP) tunable filter spectrometer, with the multi-channel multiplexing advantage of FT and/or grating/detector array. The key concept is to design and operate a tunable FP filter in a multiple-order condition. This filter is then followed by a “low-resolution” fixed grating, which disperses the filtered n-order signal into a preferably matched N-element detector array for parallel detection. The spectral resolution in this system is determined by the FP filter, which can be designed to have very high resolution. The N-order parallel detection scheme reduces the total integration or scan time by a factor of N to achieve the same signal to noise ratio (SNR) at the same resolution as the single channel tunable filter method. This design is also very flexible, allowing spectrometer systems with appropriate order N to thereby optimize the system performance for spectral resolution and scan integration time. In addition to the significant reduction in scan integration time, there are two other advantages to this approach. The first, because the FP tunable filter is designed and operated under n-orders, the fabrication tolerances of the FP filter cavity and operating conditions are significantly loosened.

### RELATED APPLICATIONS

This application claims the benefit of U.S. Provisional Application No. 60/512,146, filed Oct. 17, 2003 and U.S. Provisional Application No. 60/550,761, filed Mar. 5, 2004, both of which are incorporated herein by reference in their entirety.

### BACKGROUND OF THE INVENTION

Most spectroscopy engines are based on one of three technologies: 1) interferometer based Fourier Transfer (FT) technology; 2) dispersion based technology in combination with a detector array; and 3) tunable filter based technology with serial scanning.

FT based technology has the advantages of high resolution and wide spectral range, and has a multiplexing advantage in that all frequency channels are measured simultaneously. FT instruments, however, are inherently large, expensive, and usually not rugged.

The dispersive instruments using gratings or acoustic optics can also have the multiplexing advantage provided by parallel channel detection. However, these technologies are ultimately limited by the number of the detector elements in the array. Compared with the tunable Fabry-Perot (FP) filter based technology, the grating/detector array based spectrometers are still an order of magnitude larger in size—the higher the required resolution, the larger the system tends to be. Moreover, as the system size increases, its ruggedness tends to decrease while power consumption increases. In addition, the detector arrays with higher number of elements become significantly more expensive. This is especially true for the near-infrared (NIR) or longer wavelength regions where the detector array technology has not achieved cost advantages of mass production, as is the case with charge coupled device (CCD) arrays, which are used in the visible region.

The tunable filter based spectrometers, especially those based on solid-state FP tunable filters, have the inherent advantages of ultra compactness, ruggedness, and low-power consumption. Moreover, the resolution can be comparable to FT spectrometers. However, due to the nature of the serial tuning mechanism, tunable filter based spectroscopy engines can require longer scan times to achieve same signal-to-noise ratio (SNR) performance, when compared with other engine technologies. This factor is especially important when the signal levels are low, e.g, Raman spectral analysis. This can be a factor inhibiting deployment in applications such as hand-held field spectrum analyzers or material identifiers.

Raman's spectroscopy is similar to infrared (IR), including NIR, spectroscopy but has several advantages. The Raman effect is also highly sensitive to slight differences in chemical composition and crystallographic structure. These characteristics make it very useful for the investigation of illegal drugs as it enables distinguishing between legal and illicit compounds, even when the compounds have similar elemental composition. Also, when using IR spectroscopy on aqueous samples, a large proportion of the vibrational spectrum can be masked by the intense water signal. In contrast, with Raman spectroscopy, aqueous samples can be more readily analyzed since the Raman signature from water is relatively weak. And, because of the poor water signature, Raman spectroscopy is often useful when analyzing biological and inorganic systems, and in studies dealing with water pollution problems. One disadvantage associated with Raman spectroscopy, however, is fluorescence of impurities in the sample.

In other cases, the Raman scattering spectrum and the infrared spectrum for a given species can be quite similar. Many times, however, their differences are such that the IR and Raman spectroscopy techniques are complimentary to each other.

Raman scattering may be regarded as an inelastic collision of an incident photon with a molecule. The photon may be scattered elastically, that is without any change in its wavelength, and this is known as Rayleigh scattering. Conversely the photon may be scattered inelastically resulting in the Raman effect.

There are two types of Raman transitions. Upon collision with a molecule a photon may lose some of its energy. This is known as Stokes radiation. Or, the photon may gain some energy—this is known as anti-Stokes radiation. This happens when the incident photon is scattered by a vibrationally excited molecule—there is gain in energy and the scattered photon has a higher frequency.

When viewed with a spectrometer it can be seen that both the Stokes and anti-Stokes radiation are composed of lines which correspond to molecular vibrations of the substance under investigation. Each compound has its own unique Raman spectrum, which can be used as a fingerprint for identification.

The Raman process is non linear. When incident photons have a low intensity, only spontaneous Raman scattering will occur. As the intensity of the incident light wave is increased, an enhancement of the scattered Raman field can occur in which initially scattered Stokes photons can promote further scattering of additional incident photons. With this process, the Stokes field grows exponentially and is known as stimulated Raman scattering (SRS).

### SUMMARY OF THE INVENTION

The present invention concerns a spectrometer that can combine the advantages of high resolution, ultra compactness, ruggedness, and low-power consumption of a tunable filter spectrometer (such as a Fabry-Perot (FP) filter), with the multi-channel advantage of FT and/or grating/detector array system.

The key concept is to design and operate a tunable, or even fixed, bandpass filter in a multiple-order (n-order) condition. This filter is then followed by a “low-resolution” dispersive element, such as a fixed grating, which disperses the filtered N-order signal into a N-element detector array for parallel detection, preferably the detector is a matched array, n=N. The spectral resolution in this system is determined by the bandpass filter, which can be designed to have very high resolution. The N-order parallel detection scheme reduces the total integration or scan time by a factor of N to achieve the same signal to noise ratio (SNR) at the same resolution as the single channel tunable filter method. This design is also very flexible, allowing spectrometer systems to be designed with the appropriate order N to thereby optimize the system performance for spectral resolution and scan integration time.

In addition to significant reduction in scan integration time, there are two other advantages to this approach. The first, because the FP filter is designed and operated under n-orders, the fabrication tolerances of the FP filter cavity and operating conditions are significantly loosened.

In other embodiments, the spectroscopy method and system combines a narrow-band tunable excitation source with the high resolution, ultra compact fixed multi-channel multiplexing spectrometer, especially for Raman applications. Instead of a multi-order tunable filter, the spectrometer can use fixed high-resolution multi-order filter and a multiplexed parallel-channel detection scheme. The tuning mechanism is facilitated by a narrow-band tunable excitation source such as a laser. Because of the nature of multi-order multi-channel parallel detection, the required tunable range for the source can be very narrow, on the order of a few nanometers.

In general, according to one aspect, the invention features a spectroscopy engine. This engine can be used for standard vibrational, e.g., IR, NIR, ultraviolet, and visible, and/or Raman spectral analysis, for example.

The engine comprises a tunable, bandpass filter that optically filters a signal from a sample. A wavelength dispersive element then spectrally disperses the sample signal that has been filtered by the tunable filter. Finally, a detector is provided for detecting the dispersed signal from the wavelength dispersive element.

In one embodiment, the tunable filter is an acousto-optic filter. In other examples, however, the tunable filter is a Fabry-Perot tunable filter, such as a micro-electro-mechanical system (MEMS) Fabry-Perot tunable filter. In one example, this filter is electrostatically driven or tuned. In other examples, this MEMS filter is piezo-electrically tuned.

In still other examples, the tunable filter can be thermally tuned by changing the temperature of the tunable filter's cavity.

An important feature, however, is that the tunable filter is a multi-order tunable filter that provides multiple passbands within a spectral band of interest.

In one example, the tunable filter has three or more passbands within a spectral band of the sample signal. Usually, these passbands are between 10 and 500 gigahertz (GHz) in width, preferably 80-150 GHz.

In one embodiment, the wavelength dispersive element is a hologram. In the preferred embodiment, the wavelength dispersive element is a grating, however. Preferably, this grating is fixed. However, in some implementations, the grating pivots or moves so as to scan the spectrum over a single detector element or a detector with fewer elements.

Preferably, the detector comprises a detector element array, such as a linear detector array. In one example, this is an InGaAs array. However, in other examples, a charged coupled device detector (CCD) array is used.

In the preferred embodiment, a lensing element is used between a sample signal input and the tunable filter for signal conditioning. A second lens is used between the dispersive element and the detector. Often, the sample signal input comprises a fiber endface because the signal is carried from the sample or sample probe to the engine using fiber optic link. However, in other examples, the sample signal is input through a slit.

In the preferred application, the spectroscopy engine is used to detect the Raman spectrum of a sample. As such, the spectroscopy engine detects Stokes and/or anti-Stokes radiation from the sample. The engine, however, can also be used for other types of spectroscopy such as IR, NIR, visible, and ultraviolet, to list a few examples. In these cases, a broadband source is typically used to illuminate the sample.

In order to detect Raman signatures, a narrowband source is required to illuminate the sample. In the preferred embodiment, the source is a laser. In one example, the source is a tunable laser, including, for example, a semiconductor gain chip and a tunable fiber Bragg grating, which provides the ability to tune the source.

For Raman applications, the source that illuminates the sample is preferably tunable in a range of about 780-790 nanometers or in a range of 975-985 nanometers. The advantages of these wavelengths is that some, efficient semiconductor laser sources are available. Specifically, high power, commodity prices lasers are available at around 980 nm because of the importance in telecommunications applications for erbium-doped fiber amplifier (EDFA) pumping. Also, in at this wavelength, fluorescence is lower than some of the shorter wavelengths.

In some applications, using the fixed wavelength excitation source, fiber grating stabilized semiconductor sources are used. Such devices have good spectral and power stability due to feedback from a fiber grating in the output fiber from the laser gain chips.

In general, according to another aspect, the invention features a spectroscopy system. This system comprises a tunable source for illuminating a sample and a bandpass filter that optically filters the signal from the sample. A wavelength dispersive element is provided for dispersing the sample signal that has been filtered by the spectral filter. Finally, the detector detects the dispersed signal from the wavelength dispersive element.

In one example, the band pass filter is a fixed filter, providing multiple passbands or orders. That it, it is not tunable or only has very limited tunability. Instead, the Raman signature is obtained by tuning the tunable source.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic view of a spectroscopy engine according to the present invention;

FIG. 2 is a schematic spectral plot illustrating the relationship between a sample spectrum, the orders of the tunable filter, and the tunable filter's tuning range;

FIG. 3 is a schematic view illustrating the optical bench layout for an embodiment of the inventive spectroscopy engine;

FIG. 4 is a schematic view of a spectroscopy system according to a second embodiment of the present invention;

FIG. 5 is a schematic view of a third embodiment of the inventive spectroscopy system;

FIG. 6 is a schematic spectral plot illustrating the relationship between the tunable filter's orders, the filter tuning range, and the excitation source tuning range;

FIG. 7 illustrates the layout of an integrated spectroscopy system at the hermetic package level, according to the present invention;

FIG. 8 illustrates another embodiment of the inventive spectroscopy system utilizing an edge filter in a transmissive configuration;

FIG. 9 is a plan view of a first embodiment of a tunable filter for the inventive spectroscopy engine;

FIG. 10 is a schematic plan view of a second embodiment of the tunable filter for the inventive spectroscopy engine;

FIG. 11 is a schematic side plan view of a third embodiment of the tunable filter for the inventive spectroscopy engine;

FIGS. 12 and 13 are side plan view and a top plan views showing a fourth embodiment of the tunable filter for the spectroscopy engine; and

FIG. 14 shows a hand-held integrated Raman spectroscopy system according to the present invention.

### DETAILED DESCRIPTION OF THE PREFERRED EMBODIMENTS

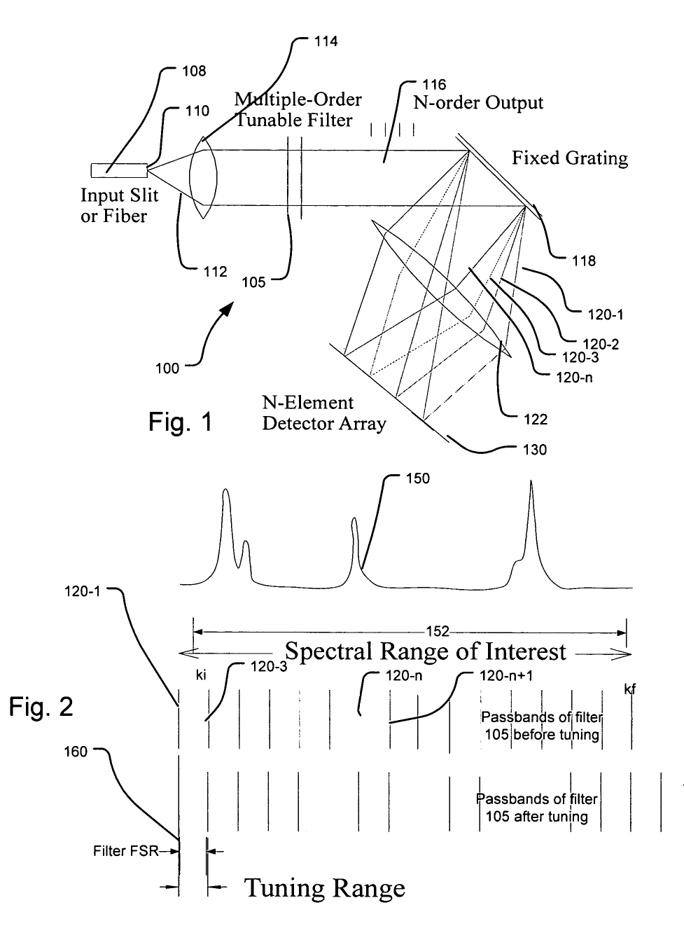

FIG. 1 illustrates a spectroscopy engine 100, which has been constructed according to the principles of the present invention.

Specifically, an input slit or fiber endface 110 functions as an aperture for sample signal source, through which a signal from a sample is provided to the spectroscopy engine 100. Often the signal same is carried to the engine using a single transverse mode or, more commonly, a multi transverse mode fiber 108.

Typically, the sample signal source 110 provides a diverging optical signal 112. A lensing element 114 is therefore used. This element 114 conditions the optical sample signal and specifically in the preferred embodiment collimates the sample signal or produces a sample signal that forms a beam waist in the diffraction limited case.

The collimated sample optical signal is provided to a multi-order or multi-passband tunable filter 105. This multi-order tunable filter 105 provides a multiple, two or three or more, spectral passbands within a signal band of the sample signal.

The filtered signal 116 from the tunable filter 105 is then provided to a dispersive element 118, e.g., grating or holographic filter element.

In the preferred embodiment, the grating 118 is a fixed grating. That is, it does not move relative to the tunable filter 105 or the optical axis of the filter signal 116.

However, in some examples, a pivoting or moving grating is used. Specifically, the grating pivots relative to the tunable filter 105 or the axis of the filtered signal beam 116 from the tunable filter 105. This tilting embodiment, while being more complex, enables the use of a single element detector, or a detector array with fewer elements, or alternatively provides a mechanism for increase spectral resolution.

The grating 118 spectrally disperses the filtered sample signal 116. Specifically, the passbands of the tunable filter are spectrally dispersed across the extent of a detector 130.

Specifically, in the illustrated example, the tunable filter 105 provides four separate passbands 120-1, 120-2, 120-3, and 120-n. However, in other examples, more or fewer passbands or orders are provided by the tunable filter 105.

In effect, the grating 118 disperses each of the orders or passbands to different regions of the detector 130. Specifically, in the illustrated example, the orders are dispersed to different regions of a multi-element detector array. In this way, the present invention provides advantages associated with a grating based-detector array system while achieving other advantages associated with a tunable filter system.

In one example, the number of passband (n) of the tunable filter, within a scan band or band of interest of the sample, is equal to the number of elements (N) in the detector array 130. In other examples, the number of elements (N) is a factor of two, three or more than the number of tunable filter passbands or orders (n).

FIG. 2 is a schematic spectral plot illustrating the operation of the combined multi-order tunable filter 105 and the grating 118.

Specifically, across the spectral range of interest 152, the multi-order tunable filter 105 provides a number of spectral pass bands (collectively reference numeral 120).

Specifically, in the illustrated example, n>15 pass bands are provided, 120-1 to 120-n. These pass bands 120 are overlaid over the spectrum of the spectrum 150 of the sample. Consequently, as illustrated by the inset 160, by tuning the tunable filter 105 over its tuning range, these spectral pass bands 120-1 to 120-n are tuned relative to the spectrum of interest 150, thereby enabling the reconstruction of the entire spectrum 150 of the sample using the N-element array 130. This is achieved when the filter tuning range is equal to or greater than the free spectral range (FSR) of the tunable filter 105, i.e., the spectral distance between each spectrally periodic passbands 120.

More generally, the grating 118 should work in the full spectral range, 152, from ki to kf. With a system having N=n parallel channels with spacing between the channels being the filter FSR. So the system spectral range is n*FSR=kf−ki. The grating operating range needs to cover at least from ki to kf.

The following sets forth some parameters for implementations of the engine 100:

Case A) n=32 (that is the tunable filter 105 provides about 32 passbands within the sampled signal band of about 200 nm or more), spectral resolution=0.5 nm, total spectral range to be covered 200 nm, and input aperture of 125 micrometers at numerical aperture (NA) of 0.22. The filter 105 required for this case has finesse of 19 at λ=1000 nm with free spectral range of less than 20 nm or about 9.45 m and optimal beam size of ˜1.0 mm in diameter. The tunable filter tuning range must be equal to or greater than 9.45 nm.

Case B) The same condition sas A) except that n=64. The filter 105 required for this case has finesse of 9 at λ=1000 nm with free spectral range of less than 6 nm or about 4.7 nm and optimal beam size of ˜1.0 mm diameter.

These requirements are achievable with a flat-flat FP filter that accepts a multi spatial mode input signal (even though Case B has less stringent requirement on the filter than Case A). Examples of such a filter are tunable liquid crystal based FP filter and a thermally-tuned solid FP filter. Other examples include multicavity bandpass filters, filter systems, and other thin film filters, for example.

In other examples, the tunable filter 105 is electro-mechanically driven, electro-magnetically driven, piezo-electrically driven, has a movable mirror element that is shape memory based, has a cavity optical refractive index that is changed by electrical properties, has a cavity optical refractive index that is changed by mechanical stress, and/or has the cavity optical refractive index that is changed by magneto-optical properties.

As a comparison, for single channel tunable filter, to achieve the same spectral performance under the same multimode input condition, the required filter finesse is 400 with free spectral range of 200 nm. The parallelism of the filter is required to be 100 times more stringent than Case A) and 200 times than Case B) discussed above.

Secondly, by not using a large detector array, i.e., when N is much smaller than 2048, for example, the cost of the detector array 130 is significantly less than full grating/detector array approach. N=32 for Case A, N=64 for Case B.

In summary, this invention retains the advantages of compact size, ruggedness, low power consumption of single FP tunable filter based spectrometer while drastically decreases spectral scan integration time and reduces the filter fabrication requirements and tolerances. These combined characteristics are critical for low cost, rugged, hand-held spectra analyzer and material identifier.

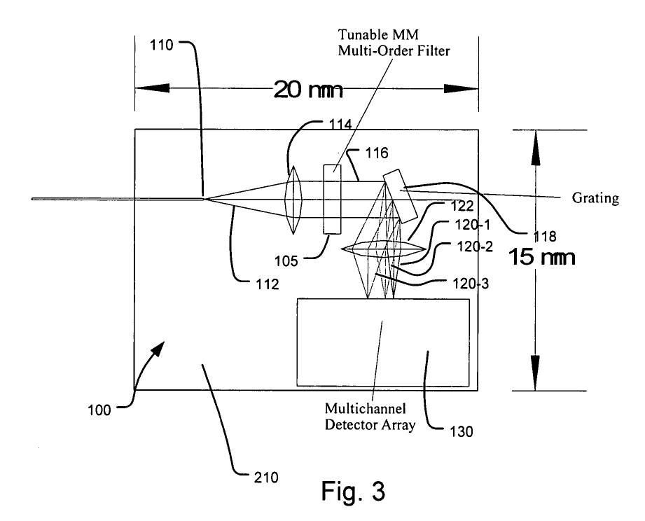

FIG. 3 illustrates the implementation of the spectroscopy engine 100 in an integrated system. Specifically, the fiber endface 110, lensing element 114, tunable or fixed multi-order filter 105, grating 118, and detector array 130 are located on a common optical bench 210. In one example, this optical bench has a length of less than 50 millimeters and width of less than 50 millimeters. In the illustrated example, its length is about 20 millimeters and its width is about 15 millimeters.

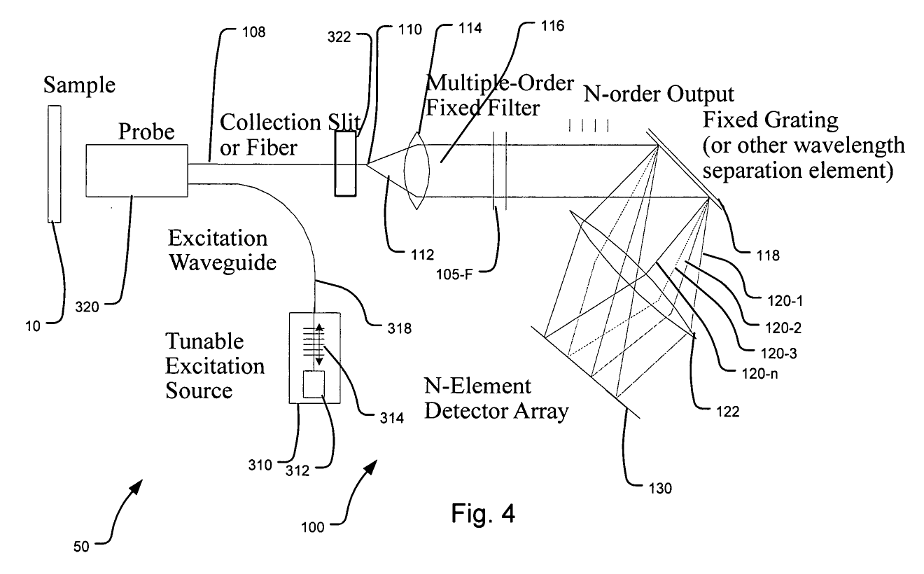

FIG. 4 illustrates a second embodiment spectroscopy system including a spectroscopy engine 100.

Specifically, the spectroscopy system 50 comprises a tunable excitation source 310. In one example, the tunable excitation source 310 comprises a semiconductor gain chip 312 and a tunable fiber Bragg grating 314.

By tuning the tunable fiber Bragg grating 314, a tunable excitation signal 316 is generated that is transmitted through the excitation waveguide 318 to a probe 320 and transferred to irradiate the sample 10.

The returning signal is coupled through the collection fiber or slit 110 to a lensing element 114 and a multi-order fixed filter 105-F.

This example detects the entire Raman spectrum by tuning the source relative to the pass bands of the multi-order fixed filter 105-F.

A tunable or fixed edge filter, which is tuned synchronously with the source 310, is used, in some in Raman configurations, to insulate the engine 100 from the usually intense signal at the excitation source wavelength.

While the passband modes of the tunable filter are stationary, in Raman spectroscopy, the Raman spectrum will shift with the changes in the excitation source wavelength due to the inelastic scattering nature of the Raman process. Thus, the entire Raman signature or spectrum of the sample 10 is resolved by scanning the tunable source over a wavelength range greater than the free spectral range of the fixed tunable filter 105-F, or frequency range between passbands.

Advantages of this embodiment include:

1. A fixed multi-order filter (etalon) can be easily precision fabricated with well-established commercial technologies. Technologies such as deposition can achieve highly uniform optical material layers compared with mechanical thinning methods. These established technologies allow low-cost components

2. Because no tuning property is required, wide-range of materials can be used, and materials are available for wide spectral coverage, from visible to NIR or longer. An example is the commonly used fused silica as the cavity material.

3. Because of the multi-order approach, the required tuning range of the source can be very narrow, matching the free-spectral-range of the multi-order filter. For example, for N=64 channels, the source tuning range required is less than 10 nm or only 4.7 nm. The narrow tuning range allows optimization of the optical output power near the peak of the gain profile, producing high output power required for Raman spectroscopy.

4. As the tuning mechanism is transferred from the filter to the source such as a laser, the beam quality requirement for the tuning element is easier since now a single-spatial-mode source is possible, whereas the tunable filter needs to accommodate extended incoherent source from the sample to maintain good throughput.

5. Since the orders of the multi-order filter are fixed in absolute wavelength space, each channel in the detection array sees a stationary beam corresponding to the associated order output from the filter. This makes the calibration much easier compared with tunable filter multi-order spectrometer approach approach, where the beam scans as the filter is been tuned.

6. A further advantage of fixed multi-order multi-channel detection is that the detector array does not require 100% (or near 100%) fill-factor. This has further cost advantage.

7. The contribution from fluorescence can be removed since the fluorescence spectrum is spectrally stationary and relatively unchanged in strength in spite of the tuning of the source. Thus, the fluorescence spectrum can be subtracted to yield a Raman-only spectrum.

Other advantages include the parallel channel processing to reduce the total integration or scan time by a factor of N to achieve the same SNR at the same resolution as the single channel tunable filter method; loosened fabrication tolerances of the FP filter cavity and operating conditions. The following two example implementations illustrate this point.

Case A) N=32, spectral resolution=0.5 nm, total spectral range to be covered 200 nm, and input aperture of 125 um at NA of 0.22. The filter required for this case has finesse of 19 at λ=1000 nm with free spectral range of less than 15 nm or 9.45 nm and optimal beam size of ˜1.0 mm diameter.

Case B) The same condition as A) except that N=64. The filter required for this case has finesse of 9 at λ=1000 nm with free spectral range of 4.7 nm and optimal beam size of ˜1.0 mm diameter.

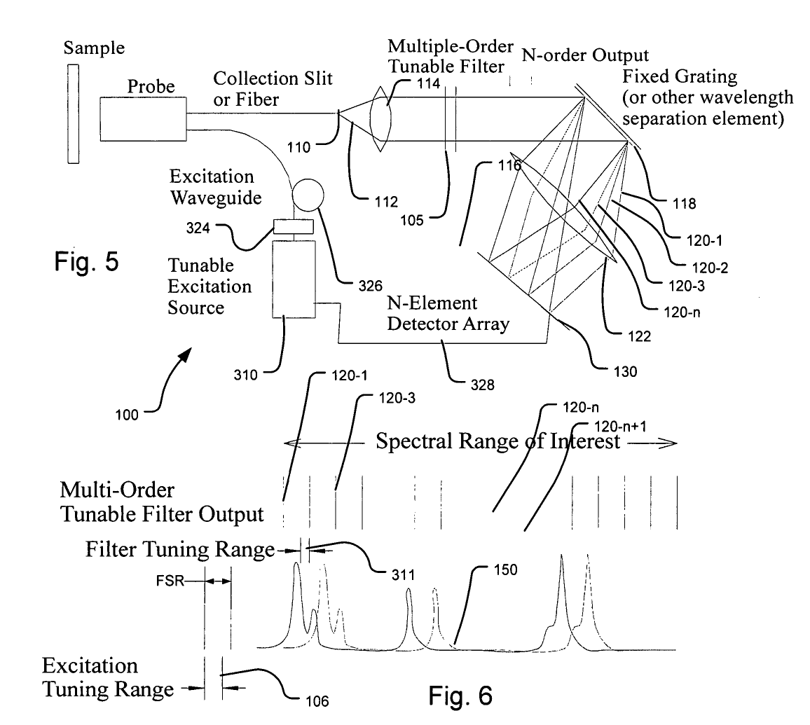

FIG. 5 shows still another embodiment that comprises a multi-order tunable filter 105 and a tunable excitation source 310. This example uses a hybrid approach as illustrated in the spectral plot of FIG. 6.

Specifically, the entire spectrum 150 of the Raman signal is detected by combining the tuning of the tunable filter 105 and the tuning of the excitation source. The tuning band 311 of the source 310 combined with the tuning band 106 of the filter 105 are greater than the filter's FSR.

In one modification, the excitation source or laser 310 is amplitude modulated. By passing the modulation signal to the detector array 130, via line 328, the detector 130 is able to use lock-in detection to remove background interference.

In one example, the modulated laser signal is further transmitted through a tunable attenuator 324 in order to reduce noise, such as relative intensity noise and mode-hoping noise in the source 324. This flattened, modulated signal is then optionally amplified in order to increase the excitation signal power in a rare-earth doped fiber amplifier 326, such as an erbium doped amplifier. In Raman applications, its high excitation power is required because the Raman process is non-linear.

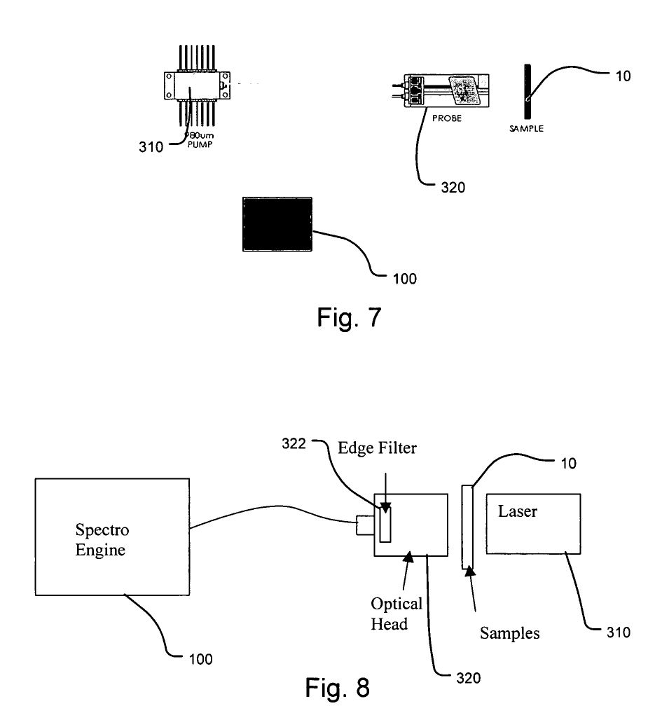

FIG. 7 illustrates one implementation of an integrated spectroscopy system 50 at the hermetic package level, according to the present invention.

Specifically, a 980 pump or other fixed or tunable semiconductor source is provided in a pigtail hermetic package 410. It is fiber-coupled to a probe 512 that couples light to the sample 10. This probe 510 also receives light and couples it into an optical fiber, typically multimode, that goes to the spectroscopy engine 100.

As illustrated in FIG. 8 in one example, an edge filter 322 is used in combination with the probe head 320, or more generally, between the probe head 320 and the spectroscopy engine 100. This insulates the spectroscopy engine 100 from the often powerful, saturating signal, generated by the excitation source 310 that is common when obtaining Raman signatures. Also in this example, the excitation source 310 is shown as illuminating the sample 10 in a transmissive fashion instead of the single reflective head relationship that transmits light to and receives light from the sample 10 as shown in FIG. 7.

The following describes some appropriate MEMS tunable filters 105 that are useful for the previously described spectroscopy systems 50.

In one embodiment, the Fabry-Perot tunable filter 105 is manufactured as described in U.S. Pat. No. 6,608,711 or 6,373,632, which are incorporated herein by this reference. One change from the systems disclosed in these incorporated patents is that a multi-spatial mode filter with a flat-flat cavity, i.e., not curved mirror, configuration is currently considered preferable for use in the spectroscopy engines 100.

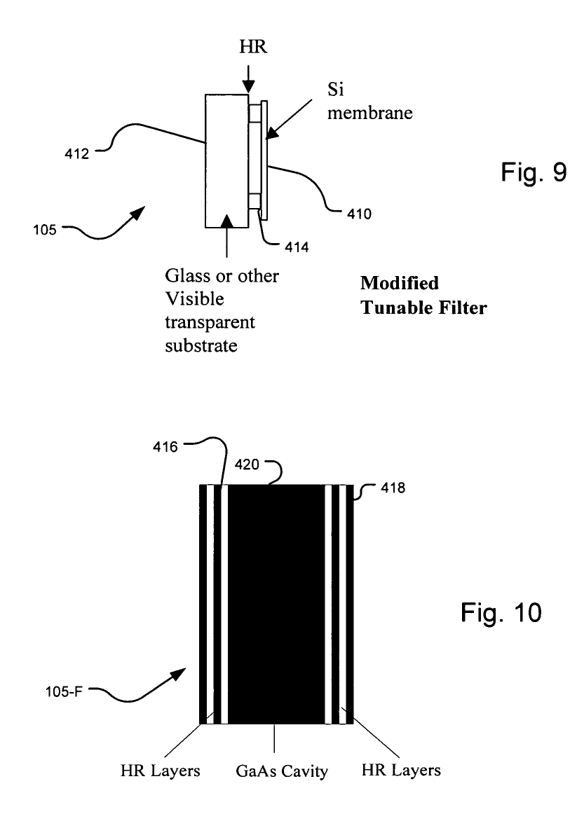

FIG. 9 illustrates another example of the tunable filter 105. In this example, a silicon or silicon nitride membrane 410, for example, is formed over a substrate 412, such as a glass substrate or silicon wafer substrate. Standoffs 414 are used to separate the membrane 410 from the substrate 412. The membrane 410 is preferably tuned by controlling the charge between the membrane 410 and the substrate 412 to provide for electrostatic tuning.

FIG. 10 shows another embodiment of the fixed filter 105-F. In this example, opposed highly reflecting mirrors 416, 418, such as formed from quarter-wave dielectric thin film coatings, are provided on either side of a cavity 420. In the illustrated example, the cavity is formed from GaAs. This can be used in a fixed filter implementation.

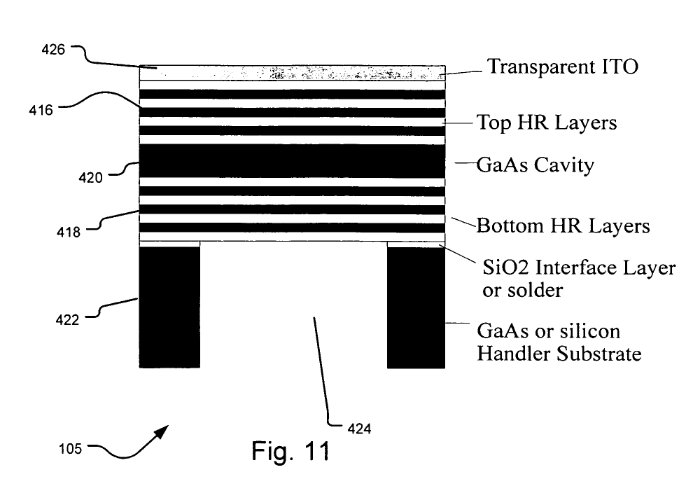

FIG. 11 illustrates an example of a thermally tunable filter 105, in which a transparent indium tin oxide (ITO) layer 426 is used as a resistive heater. A GaAs handle substrate 422 is provided in order to manipulate the tunable filter 105. An optical port 424 is formed through the handle substrate 422, although in other embodiments, antireflective coatings are used on the substrate.

In this example, the ITO layer is used as a resistive layer. Specifically, by passing electric current through this conductive ITO layer 426, the tunable filter 105 is heated to thereby control the index of refraction of the GaAs cavity 420. This results in a thermally tunable tunable filter 105 by thereby changing the optical length of the cavity between highly reflective (HR), mirror layers 416 and 418.

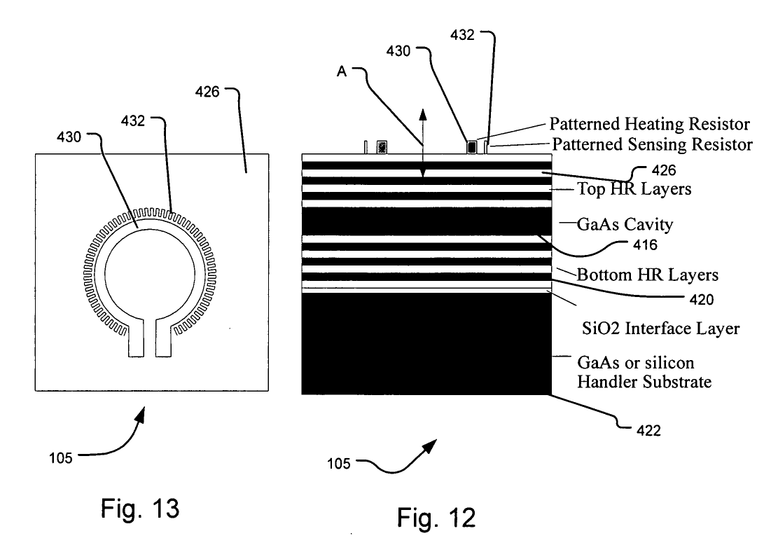

FIGS. 12 and 13 show still another embodiment in which a patterned heating resistive layer-electrode 430 and a sensing resistor layer electrode 432 have been formed on a front face of the top HR layer 426 of the tunable filter 105. Specifically by running current through the patterned heating resistor 430, in a ring around an optical axis A, the temperature of the tunable filter bulk material 105 such as cavity 416 is controlled to thereby yield a tunable filter system. The sense resistive element 432 is used to detect temperature by measuring changes in the resistance of the sense resistor 432.

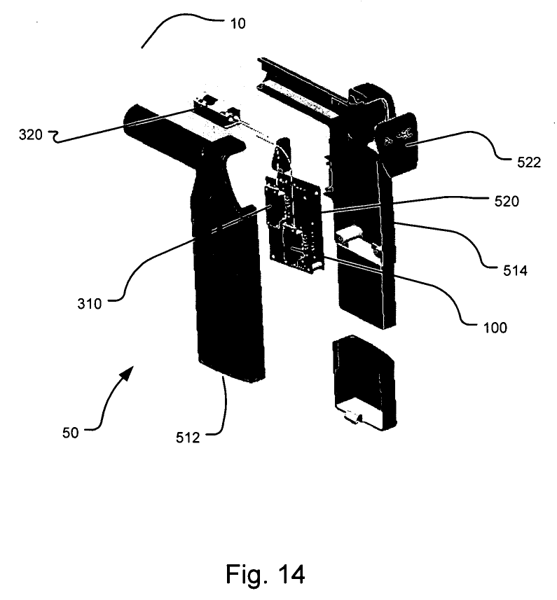

FIG. 14 illustrates an exploded view of the integrated spectroscopy system 50. Specifically, an outer casing is provided by two case elements 512, 514. These fit together around a probe element 320 and a circuit board system 520. On the circuit board system is the excitation source 310 in a butterfly package and the spectroscopy engine 100 in a second butterfly package. Further provided is a display 522 providing user interface that enables substance identification information, in one application, to be provided to the operator.

While this invention has been particularly shown and described with references to preferred embodiments thereof, it will be understood by those skilled in the art that various changes in form and details may be made therein without departing from the scope of the invention encompassed by the appended claims.

1. A spectroscopy engine, comprising:
a tunable filter that optically filters a signal from a sample;
a wavelength dispersive element for spectrally dispersing the sample signal that has been filtered by the tunable filter; and
a detector for detecting the dispersed signal from the wavelength dispersive element.

2. A spectroscopy engine as claimed in claim 1, wherein the tunable filter is an acousto-optic filter.

3. A spectroscopy engine as claimed in claim 1, wherein the tunable filter is a Fabry-Perot tunable filter.

4. A spectroscopy engine as claimed in claim 1, wherein the tunable filter is a micro-electro-mechanical system Fabry-Perot tunable filter that is electrostatically driven.

5. A spectroscopy engine as claimed in claim 1, wherein the tunable filter is a Fabry-Perot tunable filter that is tunable by changing a temperature of the tunable filter.

6. A spectroscopy engine as claimed in claim 1, wherein the tunable filter is a multi-order tunable filter providing multiple passbands within a spectral band of the sample signal.

7. A spectroscopy engine as claimed in claim 1, wherein the tunable filter is a multi-order tunable filter providing three or more passbands within a spectral band of the sample signal.

8. A spectroscopy engine as claimed in claim 1, wherein spectral passbands of the tunable filter are between 10 and 500 GigaHertz in width.

9. A spectroscopy engine as claimed in claim 1, wherein the wavelength dispersive element comprises a hologram.

10. A spectroscopy engine as claimed in claim 1, wherein the wavelength dispersive element comprises a grating.

11. A spectroscopy engine as claimed in claim 10, wherein the grating is fixed.

12. A spectroscopy engine as claimed in claim 10, wherein the grating is dispersive over a wavelength range corresponding to the spectral band of the sample signal.

13. A spectroscopy engine as claimed in claim 1, wherein the detector comprises a single detector element.

14. A spectroscopy engine as claimed in claim 1, wherein the detector comprises a linear detector array.

15. A spectroscopy engine as claimed in claim 1, wherein the detector comprises an InGaAs detector array.

16. A spectroscopy engine as claimed in claim 1, wherein the detector comprises a charge-coupled device detector array.

17. A spectroscopy engine as claimed in claim 1, wherein the detector comprises a semiconductor-based detector array.

18. A spectroscopy engine as claimed in claim 1, further comprising a lensing element between a sample signal input and the tunable filter for signal conditioning.

19. A spectroscopy engine as claimed in claim 18, wherein the sample signal input comprises a fiber endface.

20. A spectroscopy engine as claimed in claim 18, wherein the sample signal input comprises a slit aperture.

21. A spectroscopy engine as claimed in claim 1, further comprising a source for illuminating the sample.

22. A spectroscopy engine as claimed in claim 21, wherein the spectroscopy engine detects Stokes and/or anti-Stokes radiation from the sample

23. A spectroscopy engine as claimed in claim 21, wherein the source is a laser.

24. A spectroscopy engine as claimed in claim 21, wherein the source is tunable laser.

25. A spectroscopy engine as claimed in claim 21, wherein the tunable laser comprises a semiconductor gain chip and a tunable fiber Bragg grating.

26. A spectroscopy engine as claimed in claim 1, further comprising a source for illuminating the sample that is tunable in a range including about 780 to 790 nanometers.

27. A spectroscopy engine as claimed in claim 1, further comprising a source for illuminating the sample that is tunable in a range including about 975 to 985 nanometers.

28. A spectroscopy engine as claimed in claim 1, wherein the spectroscopy engine detects Stokes and/or anti-Stokes radiation from the sample.

29. A spectroscopy system, comprising:
a tunable source for illuminating a sample;
a bandpass filter that optically filters a signal from the sample;
a wavelength dispersive element for spectrally dispersing the sample signal that has been filtered by the spectral filter; and
a detector for detecting the dispersed signal from the wavelength dispersive element.

30. A spectroscopy system as claimed in claim 29, wherein the tunable source is tunable in a range including about 780 to 790 nanometers.

31. A spectroscopy system as claimed in claim 29, wherein the tunable source is tunable in a range including about 975 to 985 nanometers.

32. A spectroscopy system as claimed in claim 29, wherein the spectroscopy system detects Stokes and/or anti-Stokes radiation from the sample

33. A spectroscopy system as claimed in claim 29, wherein the bandpass filter is an acousto-optic filter.

34. A spectroscopy system as claimed in claim 29, wherein a passband of the filter is between 10 and 500 GigaHertz in width.

35. A spectroscopy system as claimed in claim 29, wherein the wavelength dispersive element comprises a hologram.

36. A spectroscopy system as claimed in claim 29, wherein the wavelength dispersive element comprises a grating.

37. A spectroscopy system as claimed in claim 36, wherein the grating is fixed.

38. A spectroscopy system as claimed in claim 36, wherein the grating is dispersive over a wavelength range corresponding to the spectral band of the sample signal.

39. A spectroscopy system as claimed in claim 29, wherein the detector comprises a single detector element.

40. A spectroscopy system as claimed in claim 29, wherein the detector comprises a linear detector array.

41. A spectroscopy system as claimed in claim 29, wherein the detector comprises an InGaAs detector array.

42. A spectroscopy system as claimed in claim 29, wherein the detector comprises a charge-coupled device detector array.

43. A spectroscopy system as claimed in claim 29, wherein the detector comprises a semiconductor-based detector array.

44. A spectroscopy system as claimed in claim 29, further comprising a lensing element between a sample signal input and the passband filter for signal conditioning.

45. A spectroscopy system as claimed in claim 44, wherein the sample signal input comprises a fiber endface.

46. A spectroscopy system as claimed in claim 44, wherein the sample signal input comprises a slit aperture.

47. A Raman spectroscopy system, comprising:
a semiconductor laser excitation source operating at about 980 nanometers for illuminating a sample; and
spectroscopy engine for detecting a Raman spectrum of the sample.

48. A method for removing fluorescence information from a detected spectrum from a sample to isolate a Raman spectrum, the method comprising:
exciting the sample with a tunable source;
removing portions of a detected spectrum that are spectrally stationary with tuning of the source thereby improve a Raman spectral information.

49. A spectroscopy method, comprising:
spectrally filtering a signal from a sample with multiple passbands;
spectrally dispersing the sample signal; and
detecting the dispersed signal with a detector array.

50. A method as claimed in claim 49, further comprising illuminating the sample with a excitation signal that has a changing wavelength.
